(19) United States
(12) Patent Application Publication
(10) Pub. No.: US 2026/0230570 A1
(43) Pub. Date: Aug. 6, 2026

(54) SCANNER WITH A FOLDABLE SUPPORT STAND

(71) Applicant: Foxlink Image Technology Co., Ltd., New Taipei City (TW)

(72) Inventors: Chien Hui Lee, New Taipei City (TW); Pai Hsien Su, New Taipei City (TW); Wen Yu Wang, New Taipei City (TW)

(21) Appl. No.: 19/257,883

(22) Filed: Jul. 2, 2025

(30) Foreign Application Priority Data
Feb. 4, 2025 (CN) 202520177422.X

(51) Int. Cl. H04N 1/00

(52) U.S. Cl. CPC H04N 1/00535; H04N 1/00559; H04N 1/00604

(57) ABSTRACT

A scanner with a foldable support stand includes a mechanical body, a first paper output tray, a second paper output tray, at least one support stand and at least one abutting element. The first paper output tray has an initial end pivotally connected to a rear side of the mechanical body, and a swingable connecting end. The second paper output tray has a pivoting portion pivotally connected to the connecting end. The at least one support stand is folded to the first paper output tray or unfolded from the first paper output tray. The at least one support stand has a fixing shaft pivotally connected to the first paper output tray, and an actuating end disposed near the connecting end. The at least one abutting element is disposed at the pivoting portion, and the at least one abutting element contacts with an outer side of the actuating end.

### CROSS REFERENCE TO RELATED APPLICATIONS

The present application is based on, and claims priority from, China Patent Application No. 202520177422.X, filed February 4, 2025, the disclosure of which is hereby incorporated by reference herein in its entirety.

### BACKGROUND OF THE INVENTION

### Field of the Invention

The present invention generally relates to a scanner, and more particularly to a scanner with a foldable support stand of which a foldable support stand is capable of automatically unfolding in the process of opening a paper output tray.

### Description of Related Art

Referring to FIG. 10, in order to facilitate users to scan a lot of documents, a conventional automatic scanner 100' is equipped with a paper input tray for accommodating the documents which are to be fed, and a paper output tray 20' for accommodating the documents which are fed out. Additionally, in order to reduce a size of the conventional automatic scanner 100' and make the conventional automatic scanner 100' more portable, the paper input tray and the paper output tray 20' are often designed to be detachable or foldable.

Referring to FIG. 10, the conventional automatic scanner 100' includes a mechanical body 10', and the paper output tray 20' pivotally connected to a rear side of the mechanical body 10'. Thus, the scanned documents may be fed out to the paper output tray 20' for a temporary storage.

However, when too many documents are stacked in the paper output tray 20', the conventional automatic scanner 100' lacks a support stand, so a gravity center of the conventional automatic scanner 100' is easily shifted and tipped over.

Therefore, it is essential to provide an innovative scanner with a foldable support stand of which a foldable support stand is capable of automatically unfolding in a process of opening a paper output tray, so that a size of the innovative scanner with the foldable support stand is maintained to be lighter, thinner and more portable.

### BRIEF SUMMARY OF THE INVENTION

An object of the present invention is to provide a scanner with a foldable support stand, comprising: a mechanical body; a first paper output tray folded to be covered to a rear side of the mechanical body or the first paper output tray unfolded from the rear side of the mechanical body, the first paper output tray having an initial end pivotally connected to the rear side of the mechanical body, and a swingable connecting end; a second paper output tray folded to be covered to a top of the mechanical body or the second paper output tray unfolded from the top of the mechanical body, the second paper output tray having a pivoting portion pivotally connected to the connecting end, and a swingable terminal end; at least one support stand folded to the first paper output tray or unfolded from the first paper output tray, the at least one support stand having a fixing shaft pivotally connected to the first paper output tray, a movable end disposed near the initial end, and an actuating end disposed near the connecting end; and at least one abutting element disposed at the pivoting portion of the second paper output tray, and the at least one abutting element contacting with an outer side of the actuating end.

Another object of the present invention is to provide a scanner with a foldable support stand, comprising: a mechanical body; a first paper output tray folded to be covered to a rear side of the mechanical body or the first paper output tray unfolded from the rear side of the mechanical body, the first paper output tray having an initial end pivotally connected to the rear side of the mechanical body, and a swingable connecting end, an outer side of the first paper output tray being recessed inward to form a receiving groove; a second paper output tray folded to be covered to a top of the mechanical body or the second paper output tray unfolded from the top of the mechanical body, the second paper output tray having a pivoting portion pivotally connected to the connecting end, and a swingable terminal end; at least one support stand having a fixing shaft pivotally connected to the first paper output tray, a movable end disposed near the initial end, and an actuating end disposed near the connecting end; and at least one abutting element disposed at the pivoting portion of the second paper output tray, and the at least one abutting element contacting with an outer side of the actuating end, wherein when the first paper output tray and the second paper output tray are folded, the at least one support stand is received in the receiving groove, when the first paper output tray and the second paper output tray are unfolded, the at least one support stand projects out of the receiving groove.

Another object of the present invention is to provide a scanner with a foldable support stand, comprising: a mechanical body; a first paper output tray folded to be covered to a rear side of the mechanical body or the first paper output tray unfolded from the mechanical body, the first paper output tray having an initial end pivotally connected to the rear side of the mechanical body, and a swingable connecting end, an outer side of the first paper output tray being recessed inward to form a receiving groove; a second paper output tray folded to be covered to a top of the mechanical body or the second paper output tray unfolded from the mechanical body, the second paper output tray having a pivoting portion pivotally connected to the connecting end; at least one support stand having a fixing shaft pivotally connected to the first paper output tray, a movable end disposed near the initial end, and an actuating end disposed near the connecting end; and at least one abutting element disposed at the pivoting portion of the second paper output tray, and the at least one abutting element contacting with an outer side of the actuating end of the at least one support stand, wherein when the first paper output tray and the second paper output tray are folded or unfolded, the second paper output tray drives the at least one abutting element to rotate so as to make the at least one support stand folded or unfolded, and the at least one support stand is received in the receiving groove or projects out of the receiving groove; and wherein an inner wall of the receiving groove defines a connecting hole communicated between the receiving groove and an inner side of the first paper output tray, the first paper output tray has a first hook disposed at the inner side of the first paper output tray, the at least one support stand has a second hook disposed at an inner side of the at least one support stand, a returning spring is connected between the first hook and the second hook through the connecting hole.

As described above, the scanner with the foldable support stand includes the mechanical body, the first paper output tray which has the initial end pivotally connected to the rear side of the mechanical body, and the swingable connecting end, the second paper output tray which has the pivoting portion pivotally connected to the connecting end, and the swingable terminal end, the at least one support stand which has the fixing shaft pivotally connected to the first paper output tray, the movable end disposed near the initial end, and the actuating end disposed near the connecting end, and the at least one abutting element disposed at the pivoting portion of the second paper output tray, the at least one abutting element contacts with the outer side of the actuating end, so the scanner with the foldable support stand is provided, and the at least one foldable support stand is capable of automatically unfolding in a process of opening a paper output tray.

### BRIEF DESCRIPTION OF THE DRAWINGS

The present invention will be apparent to those skilled in the art by reading the following description, with reference to the attached drawings, in which:

FIG. 1 is a cross-sectional diagram of a scanner with a foldable support stand according to the present invention;

FIG. 2 is a perspective diagram of the scanner with the foldable support stand according to the present invention, wherein the scanner with the foldable support stand is in a folded state;

FIG. 3 is another perspective diagram of the scanner with the foldable support stand according to the present invention, wherein the scanner with the foldable support stand is in an unfolded state;

FIG. 4 is a cross-sectional view of a first paper output tray of the scanner with the foldable support stand according to the present invention;

FIG. 5 is a cross-sectional view of a support stand of the scanner with the foldable support stand according to the present invention;

FIG. 6 is a perspective view of a paper output tray of the scanner with the foldable support stand according to the present invention, wherein an elastic returning element of the scanner with the foldable support stand is enlarged;

FIG. 7 is a cross-sectional diagram of the scanner with the foldable support stand according to the present invention, wherein the scanner with the foldable support stand is in the folded state;

FIG. 8 is a cross-sectional diagram of the scanner with the foldable support stand according to the present invention, wherein the scanner with the foldable support stand is in an unfolding process;

FIG. 9 is a cross-sectional diagram of the scanner with the foldable support stand according to the present invention, wherein the scanner with the foldable support stand is in the unfolded state; and

FIG. 10 is a perspective diagram of a conventional automatic scanner in prior art.

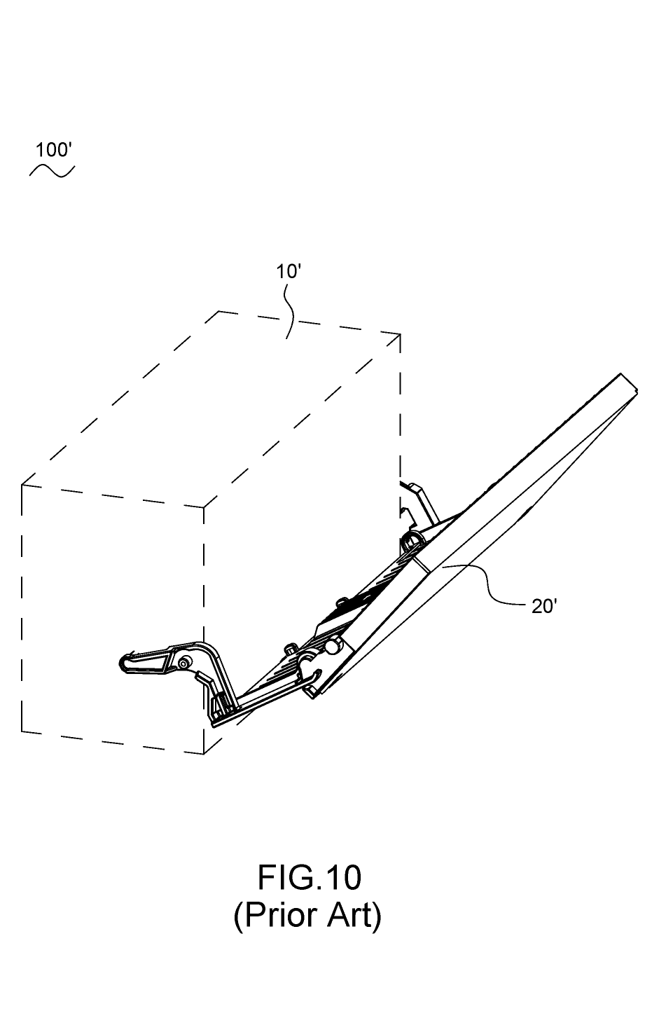

### DETAILED DESCRIPTION OF THE INVENTION

In order to provide a detailed explanation of a technical content, structural features, achieved purposes and effects of the present invention, a following embodiment is provided with accompanying diagrams for a detailed illustration.

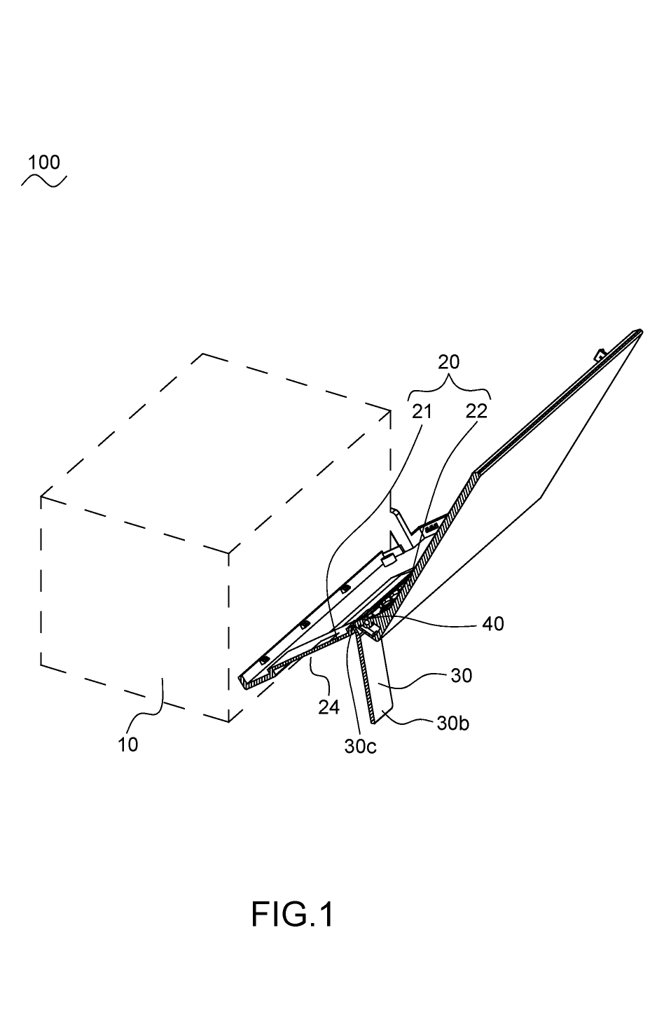

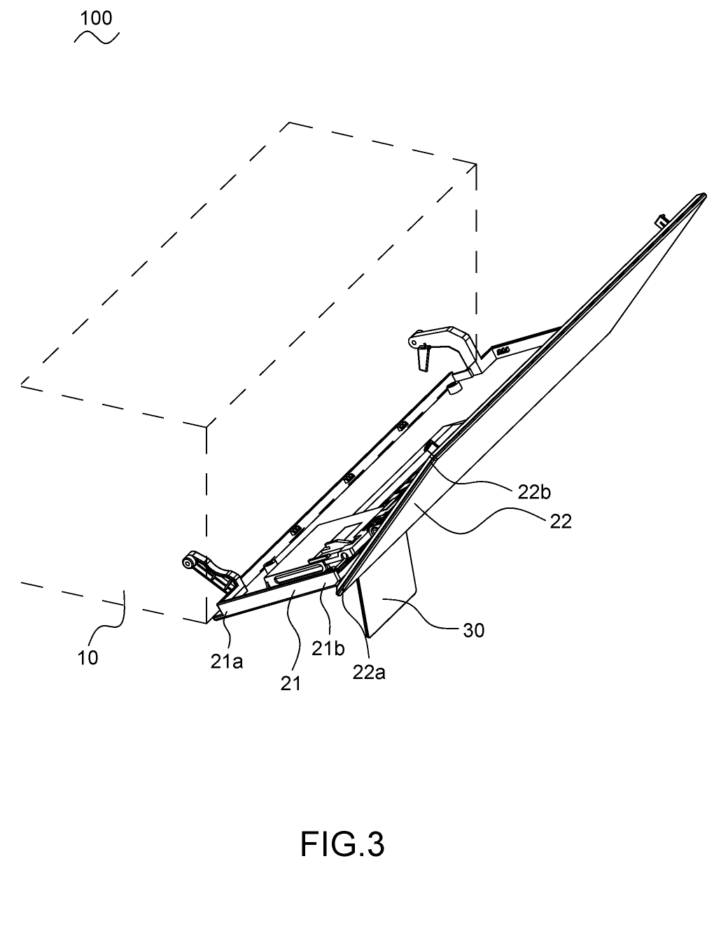

Referring to FIG. 1 to FIG. 3, a scanner with a foldable support stand 100 according to the present invention is shown. The scanner with the foldable support stand 100 includes a mechanical body 10, a first paper output tray 21 having an initial end 21a pivotally connected to a rear side of the mechanical body 10 and a swingable connecting end 21b, and a second paper output tray 22 having a pivoting portion 22a pivotally connected to the connecting end 21b, and a swingable terminal end 22b.

The first paper output tray 21 and the second paper output tray 22 are able to be folded to be covered to the rear side of the mechanical body 10 and a top of the mechanical body 10. The second paper output tray 22 is pivotally connected to the first paper output tray 21. When a document starts being scanned, the first paper output tray 21 and the second paper output tray 22 are unfolded to form a paper output tray 20 for loading the document. The first paper output tray 21 is folded to be covered to the rear side of the mechanical body 10 or the first paper output tray 21 is unfolded from the rear side of the mechanical body 10. The second paper output tray 22 is folded to be covered to the top of the mechanical body 10 or the second paper output tray 22 is unfolded from the top of the mechanical body 10.

For a convenience of a description, directions of the paper output tray 20 of the scanner with the foldable support stand 100 in this description are defined as follows. An inner side of the paper output tray 20 is defined as a side that loads the document when the first paper output tray 21 and the second paper output tray 22 are unfolded, and the side that contacts the mechanical body 10 when the first paper output tray 21 and the second paper output tray 22 are folded. An outer side of the paper output tray 20 is defined as a side facing a desktop when the first paper output tray 21 and the second paper output tray 22 are unfolded, and the side opposite to the mechanical body 10 when the first paper output tray 21 and the second paper output tray 22 are folded.

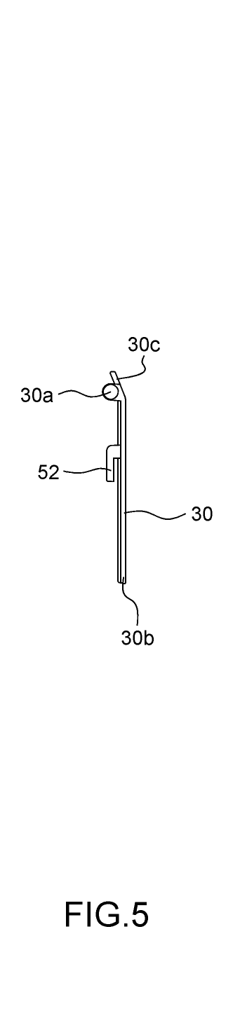

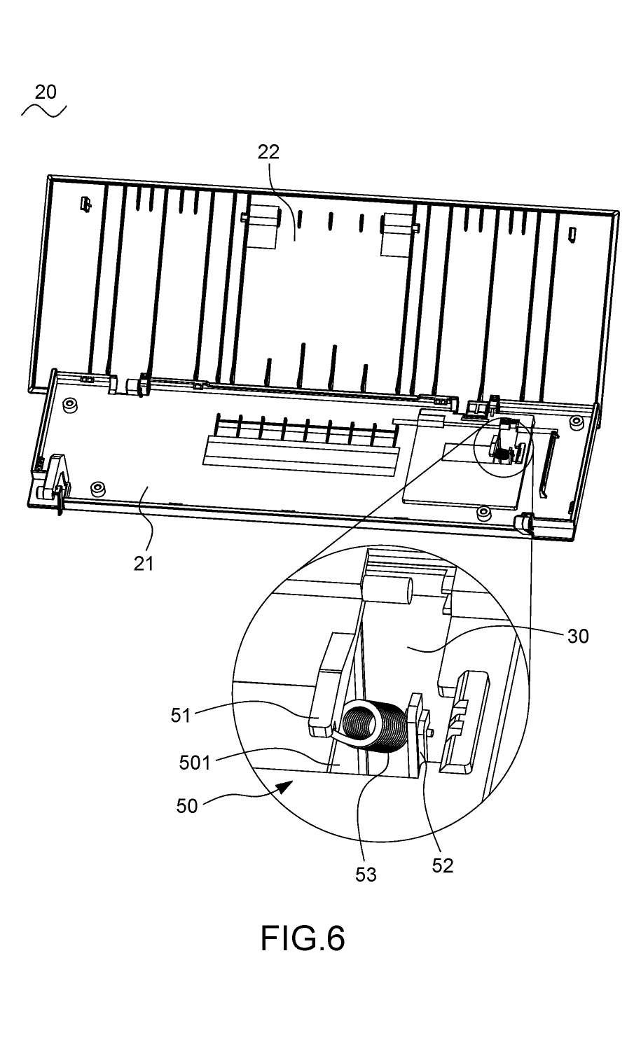

Referring to FIG. 1 to FIG. 6, in order to ensure that the scanner with the foldable support stand 100 stands stably, the scanner with the foldable support stand 100 includes at least one support stand 30. The at least one support stand 30 has a fixing shaft 30a pivotally connected to the first paper output tray 21, a movable end 30b disposed near the initial end 21a, and an actuating end 30c disposed near the connecting end 21b.

The second paper output tray 22 has at least one abutting element 40. The at least one abutting element 40 is disposed at the pivoting portion 22a of the second paper output tray 22, and the at least one abutting element 40 contacts with an outer side of the actuating end 30c of the at least one support stand 30. The outer side of the actuating end 30c is opposite to the mechanical body 10. Because the at least one abutting element 40 is disposed at the pivoting portion 22a of the second paper output tray 22, and the at least one abutting element 40 contacts with the outer side of the actuating end 30c, when the first paper output tray 21 and the second paper output tray 22 are unfolded, the at least one abutting element 40 pushes against the outer side of the actuating end 30c, the at least one abutting element 40 drives the actuating end 30c to rotate inward, and then the movable end 30b of the at least one support stand 30 is pushed outward.

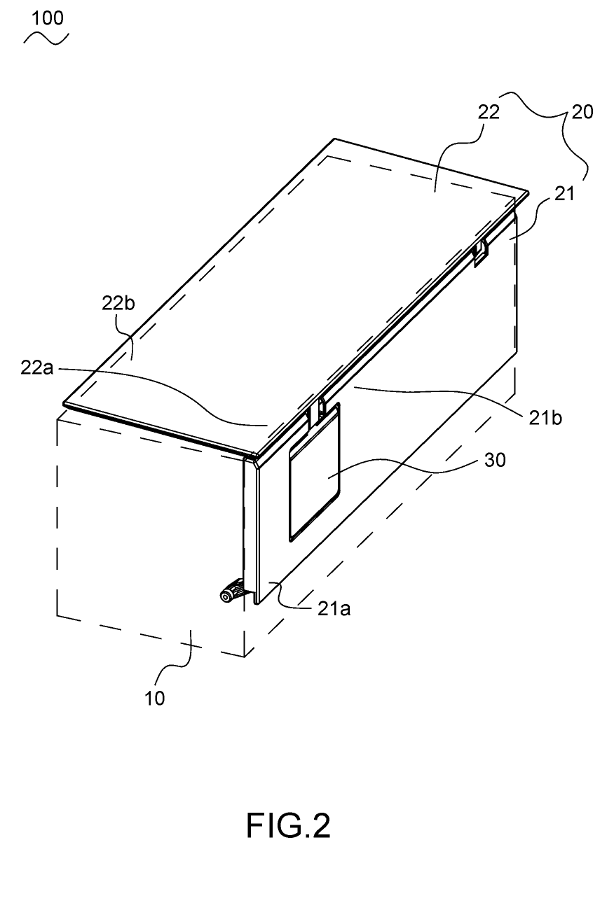

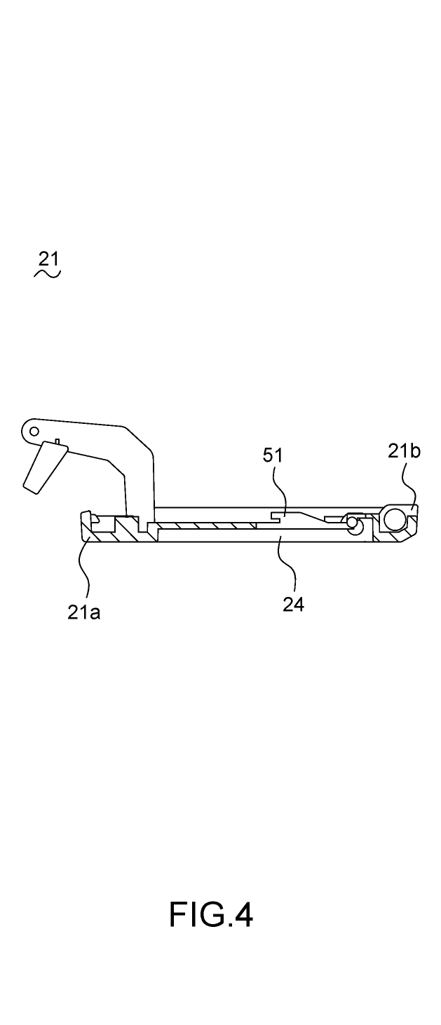

Referring to FIG. 1, FIG. 2 and FIG. 4, in this present invention, an outer side of the first paper output tray 21 is recessed inward to form a receiving groove 24 to accommodate the at least one support stand 30. An inner wall of the receiving groove 24 defines a connecting hole 501 communicated between the receiving groove 24 and the inner side of the first paper output tray 21. The at least one support stand 30 is folded to the first paper output tray 21 or is unfolded from the first paper output tray 21. When the first paper output tray 21 and the second paper output tray 22 are folded, the at least one support stand 30 is received in the receiving groove 24. When the first paper output tray 21 and the second paper output tray 22 are unfolded, the at least one support stand 30 projects out of the receiving groove 24. When the first paper output tray 21 and the second paper output tray 22 are folded or unfolded, the second paper output tray 22 drives the at least one abutting element 40 to rotate so as to make the at least one support stand 30 folded or unfolded, and the at least one support stand 30 is received in the receiving groove 24 or projects out of the receiving groove 24.

With reference to FIG. 1 to FIG. 6, in order to enable the at least one support stand 30 to be automatically folded when the at least one support stand 30 is unused, the scanner with the foldable support stand 100 further includes an elastic returning element 50. The elastic returning element 50 is positioned between the at least one support stand 30 and the first paper output tray 21. The first paper output tray 21 includes a first hook 51 disposed at the inner side of the first paper output tray 21, the at least one support stand 30 has a second hook 52 disposed at an inner side of the at least one support stand 30, and a returning spring 53 connected between the first hook 51 and the second hook 52 through the connecting hole 501.

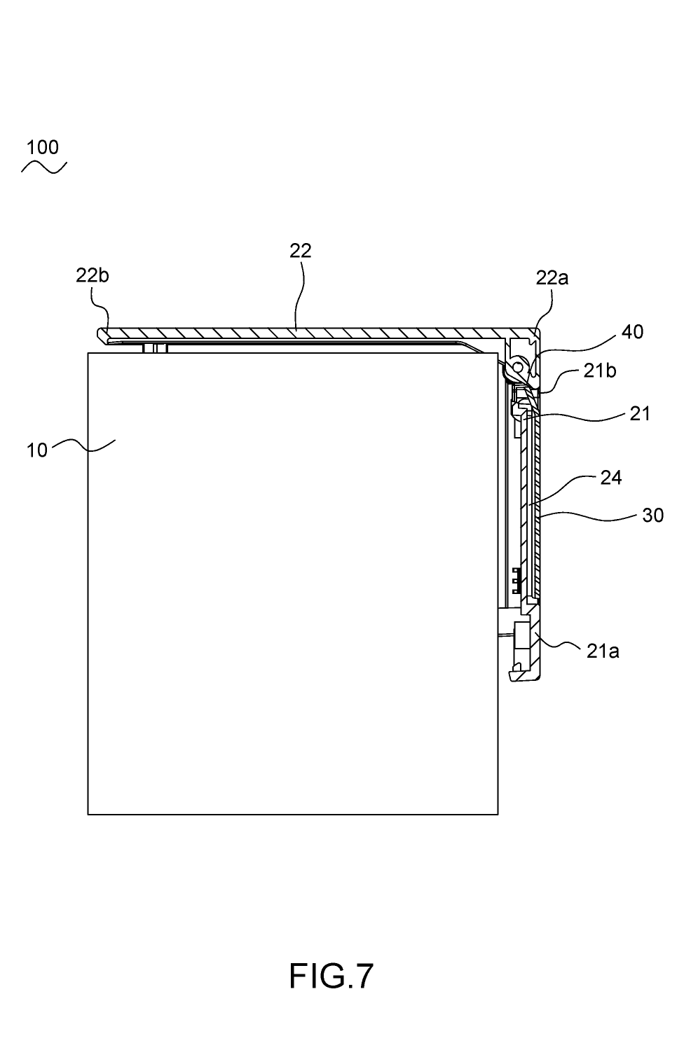

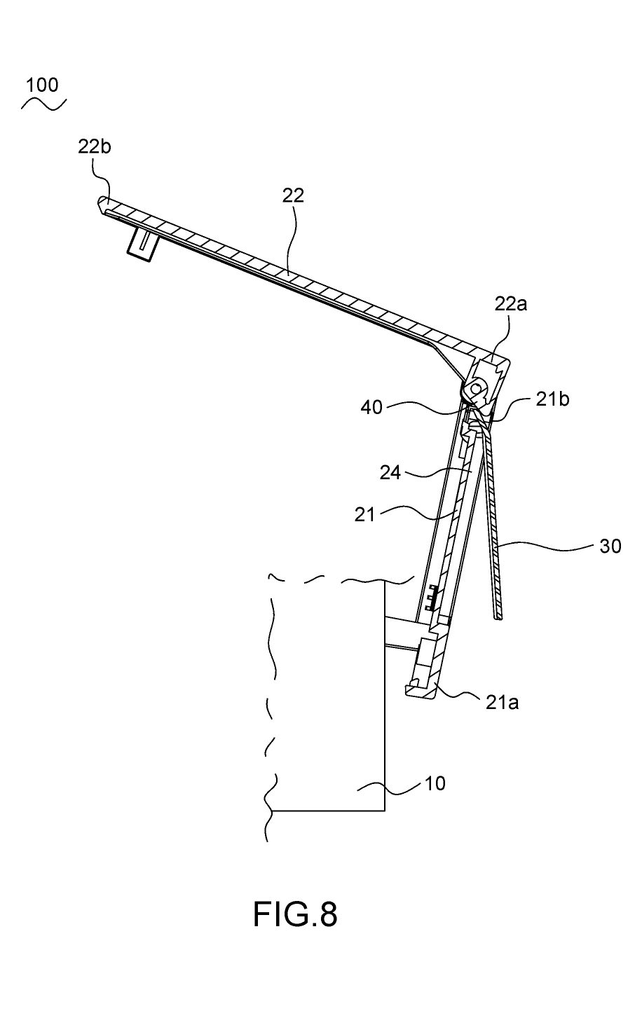

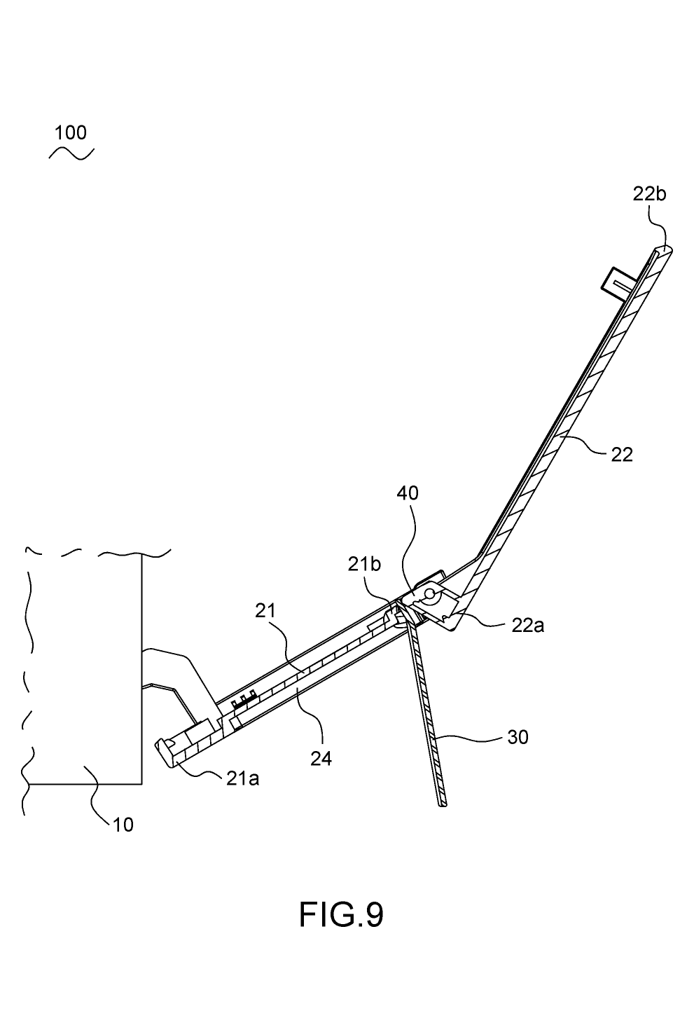

With reference to FIG. 7 to FIG. 9, when the user starts scanning the documents, the first paper output tray 21 and the second paper output tray 22 are unfolded. At the moment, the at least one abutting element 40 disposed at the pivoting portion 22a rotates in a clockwise direction to push against the outer side of the actuating end 30c of the at least one support stand 30, and the at least one support stand 30 rotates in a counterclockwise direction to be unfolded. The scanner with the foldable support stand 100 is in an unfolding process.

When the at least one support stand 30 is fully unfolded, a weight of the first paper output tray 21 and a weight of the second paper output tray 22 maintain the at least one support stand 30 in an unfolded state, so the scanner with the foldable support stand 100 is in an unfolded state. After completing scanning the documents, the user directly folds the first paper output tray 21 and the second paper output tray 22. When the at least one abutting element 40 rotates in the counterclockwise direction to make the at least one support stand 30 rotate in the clockwise direction, the at least one support stand 30 is folded under an action of the elastic returning element 50 which is resiliently disposed between the at least one support stand 30 and the first paper output tray 21, and then the scanner with the foldable support stand 100 is in a folded state.

As described above, the scanner with the foldable support stand 100 includes the mechanical body 10, the first paper output tray 21 which has the initial end 21a pivotally connected to the rear side of the mechanical body 10, and the swingable connecting end 21b, the second paper output tray 22 which has the pivoting portion 22a pivotally connected to the connecting end 21b, and the swingable terminal end 22b, the at least one support stand 30 which has the fixing shaft 30a pivotally connected to the first paper output tray 21, the movable end 30b disposed near the initial end 21a, and the actuating end 30c disposed near the connecting end 21b, and the at least one abutting element 40 disposed at the pivoting portion 22a of the second paper output tray 22, the at least one abutting element 40 contacts with the outer side of the actuating end 30c, so the scanner with the foldable support stand 100 is provided, and the at least one foldable support stand 30 is capable of automatically unfolding in a process of opening the paper output tray 20.

What is claimed is:

1. A scanner with a foldable support stand, comprising:
a mechanical body;
a first paper output tray folded to be covered to a rear side of the mechanical body or the first paper output tray unfolded from the rear side of the mechanical body, the first paper output tray having an initial end pivotally connected to the rear side of the mechanical body, and a swingable connecting end;
a second paper output tray folded to be covered to a top of the mechanical body or the second paper output tray unfolded from the top of the mechanical body, the second paper output tray having a pivoting portion pivotally connected to the connecting end, and a swingable terminal end;
at least one support stand folded to the first paper output tray or unfolded from the first paper output tray, the at least one support stand having a fixing shaft pivotally connected to the first paper output tray, a movable end disposed near the initial end, and an actuating end disposed near the connecting end; and
at least one abutting element disposed at the pivoting portion of the second paper output tray, and the at least one abutting element contacting with an outer side of the actuating end.

2. The scanner with the foldable support stand as claimed in claim 1, wherein an outer side of the first paper output tray is recessed inward to form a receiving groove, when the first paper output tray and the second paper output tray are folded, the at least one support stand is received in the receiving groove.

3. The scanner with the foldable support stand as claimed in claim 2, further comprising an elastic returning element, the elastic returning element being positioned between the at least one support stand and the first paper output tray.

4. The scanner with the foldable support stand as claimed in claim 3, wherein an inner wall of the receiving groove defines a connecting hole communicated between the receiving groove and an inner side of the first paper output tray, the first paper output tray has a first hook disposed at the inner side of the first paper output tray, the at least one support stand has a second hook disposed at an inner side of the at least one support stand, a returning spring is connected between the first hook and the second hook through the connecting hole.

5. The scanner with the foldable support stand as claimed in claim 1, wherein the outer side of the actuating end is opposite to the mechanical body.

6. The scanner with the foldable support stand as claimed in claim 1, wherein the second paper output tray is pivotally connected to the first paper output tray, when a document starts being scanned, the first paper output tray and the second paper output tray are unfolded to form a paper output tray.

7. The scanner with the foldable support stand as claimed in claim 1, wherein when a user starts scanning documents, the first paper output tray and the second paper output tray are unfolded, the at least one abutting element rotates in a clockwise direction to push against the outer side of the actuating end of the at least one support stand, and the at least one support stand rotates in a counterclockwise direction to be unfolded.

8. The scanner with the foldable support stand as claimed in claim 1, wherein when the at least one support stand is fully unfolded, a weight of the first paper output tray and a weight of the second paper output tray maintain the at least one support stand in an unfolded state.

9. The scanner with the foldable support stand as claimed in claim 1, wherein after completing scanning documents, a user directly folds the first paper output tray and the second paper output tray, when the at least one abutting element rotates in a counterclockwise direction to make the at least one support stand rotate in a clockwise direction, the at least one support stand is folded under an action of an elastic returning element which is resiliently disposed between the at least one support stand and the first paper output tray.

10. A scanner with a foldable support stand, comprising:
a mechanical body;
a first paper output tray folded to be covered to a rear side of the mechanical body or the first paper output tray unfolded from the rear side of the mechanical body, the first paper output tray having an initial end pivotally connected to the rear side of the mechanical body, and a swingable connecting end, an outer side of the first paper output tray being recessed inward to form a receiving groove;
a second paper output tray folded to be covered to a top of the mechanical body or the second paper output tray unfolded from the top of the mechanical body, the second paper output tray having a pivoting portion pivotally connected to the connecting end, and a swingable terminal end;
at least one support stand having a fixing shaft pivotally connected to the first paper output tray, a movable end disposed near the initial end, and an actuating end disposed near the connecting end; and
at least one abutting element disposed at the pivoting portion of the second paper output tray, and the at least one abutting element contacting with an outer side of the actuating end,
wherein when the first paper output tray and the second paper output tray are folded, the at least one support stand is received in the receiving groove, when the first paper output tray and the second paper output tray are unfolded, the at least one support stand projects out of the receiving groove.

11. A scanner with a foldable support stand, comprising:
a mechanical body;
a first paper output tray folded to be covered to a rear side of the mechanical body or the first paper output tray unfolded from the mechanical body, the first paper output tray having an initial end pivotally connected to the rear side of the mechanical body, and a swingable connecting end, an outer side of the first paper output tray being recessed inward to form a receiving groove;
a second paper output tray folded to be covered to a top of the mechanical body or the second paper output tray unfolded from the mechanical body, the second paper output tray having a pivoting portion pivotally connected to the connecting end;
at least one support stand having a fixing shaft pivotally connected to the first paper output tray, a movable end disposed near the initial end, and an actuating end disposed near the connecting end; and
at least one abutting element disposed at the pivoting portion of the second paper output tray, and the at least one abutting element contacting with an outer side of the actuating end of the at least one support stand,
wherein when the first paper output tray and the second paper output tray are folded or unfolded, the second paper output tray drives the at least one abutting element to rotate so as to make the at least one support stand folded or unfolded, and the at least one support stand is received in the receiving groove or projects out of the receiving groove; and
wherein an inner wall of the receiving groove defines a connecting hole communicated between the receiving groove and an inner side of the first paper output tray, the first paper output tray has a first hook disposed at the inner side of the first paper output tray, the at least one support stand has a second hook disposed at an inner side of the at least one support stand, a returning spring is connected between the first hook and the second hook through the connecting hole.
